(19) United States
(12) Patent Application Publication
(10) Pub. No.: US 2006/0095279 A1
(43) Pub. Date: May 4, 2006

(54) Network support for post office box mail deposit notification

(76) Inventors: David S. Benco, Winfield, IL (US); Sanjeev Mahajan, Naperville, IL (US); Baoling S. Sheen, Naperville, IL (US); Sandra L. True, St. Charles, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 10/980,449

(22) Filed: Nov. 3, 2004

(51) Int. Cl. G06Q 99/00

(52) U.S. Cl. 705/1

(57) ABSTRACT

Embodiments of the method and system provide for notifying a post office box renter when mail is available for pickup. The method in an embodiment may have the steps of: detecting at least one mail item in a post office box; sending a signal indicative of the mail item being in the post office box to a P.O. Box Mail Notification Server; sending a message from the P.O. Box Mail Notification Server to a mobile switching center; and sending a notification indicating the presence of mail in the post office box from the mobile switching center to a mobile terminal associated with the post office box. The system implements the method.

### TECHNICAL FIELD

The present invention relates to wireless telephony in general, and, more particularly, to a method and system that notifies a post office box renter when mail is available for pickup.

### BACKGROUND OF THE INVENTION

Many businesses and individuals rent post office boxes in order to receive mail. However, this method of receiving mail requires that they make a trip to the post office to pick up their mail. Often they make the trip to only find that there was no mail for them. It is therefore a drawback that a post office box renter cannot receive notification when they have mail waiting to be picked up. This results in an unnecessary expense and a waste of time for the post office box renter.

### SUMMARY

The following summary of embodiments of the invention is provided to facilitate an understanding of some of the innovative features unique to the present invention and is not intended to be a full description. A full appreciation of the various aspects of the invention can be gained by taking the entire specification, claims, drawings, and abstract as a whole.

In general terms, an embodiment of the present method is a method notifying a post office box renter when mail is available for pickup. The method in this embodiment may have the steps of: detecting at least one mail item in a post office box and detecting when the post office box is empty; sending a signal indicative of the mail item being in the post office box to a P.O. Box Mail Notification Server; sending a message from the P.O. Box Mail Notification Server to a mobile switching center; and sending a notification indicating the presence of mail in the post office box from the mobile switching center to a mobile terminal associated with the post office box.

Also, in general terms, an embodiment of the present system is a system that provides network support for notifying a post office box renter when mail is available for pickup. The system in this embodiment may have the following components: at least one post office box having a mail sensor that outputs a sensor signal indicative of at least one mail item being in the post office box; a P.O. Box Mail Notification Server operatively coupled to the mail sensor; and a short message center operatively coupled to the P.O. Box Mail Notification Server, the short message center outputting a text message to a mobile switching center when mail is present in the post office box; wherein the mobile switching center sends at least one notification, which indicates the presence of mail in the post office box, to a respective mobile terminal associated with the post office box.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts a block diagram illustrative of a mobile switching center, base station and mobile terminal for use with embodiments of the present method and system.

FIG. 2 illustrates a more detailed block diagram illustrative of a mobile switching center, base station, and mobile terminal used with one embodiment of the present method and system.

FIG. 3 illustrates a very general flow chart of logical operational steps that may be followed in accordance with one embodiment of the present method and system.

FIG. 4 illustrates another flow chart of logical operational steps that may be followed in accordance with one embodiment of the present method and system.

### DETAILED DESCRIPTION

The particular values and configurations discussed in these non-limiting examples can be varied and are cited merely to illustrate an embodiment of the present invention and are not intended to limit the scope of the invention.

Mobile subscribers are becoming increasingly connected to their mobile handsets (also referred to as mobile terminals), which are often carried daily. Embodiments of the present method and system provide notification to a post office box renter when mail in the renter's post office box is available for pickup.

Typical wireless communication networks, such as those operating in accordance with the Code Division Multiple Access (CDMA) standard, generally have a plurality of radio base stations, which may be connected to a mobile switching centerEach base station covers a limited area, generally called a cell, within which a wireless communication link can be established with a mobile terminal such as a cell phone. A call in progress can be handed over from one base station to another while the mobile terminal is moving in the coverage area of the network.

Methodologies of the present method and system may include at least one of: detecting that there is mail in the post office box; notifying the renter of the waiting mail; and detecting that there is no mail in the post office box.

In an embodiment of the present method and apparatus each post office box (also referred to as a PO Box) may be equipped with a weight-detecting device that can detect small weights like a post card. The weight-detecting device may be coupled to a “PO Box Mail Notification Server” at the post office. PO Box Mail Notification Server may be a specialized computer with a custom built application structured to implement the embodiments of the present method and system as described below.

The P.O. Box Mail Notification Server may be connected to a mobile SMS (short message service) center. The P.O. Box Mail Notification Server may be connected via the Internet or a dedicated network. Having a dedicated network between the post office and the P.O. Box Mail Notification Server would eliminate the chances of message loss in the Internet.

When a first mail item is added to the PO Box the weight-detecting device detects that the weight in the PO Box has gone from zero to a positive weight and sends a signal to the P.O. Box Mail Notification Server that it has mail. The P.O. Box Mail Notification Server may then send a text message to the Short Message Center (SMC) identifying the P.O. Box owner. The SMC provides store and forward switching as is known in the art. The MSC may check if the subscriber has subscribed to this feature. If so, the MSC may then send the text message to the respective mobile subscriber.

When the PO Box is emptied the weight-detecting device detects that the weight in the PO Box has gone to zero and sends a signal to the P.O. Box Mail Notification Server notifying it that the PO box is empty. As an alternative to SMS the notification may be sent via packet data, or a voice notification may be provided on the specified phone number.

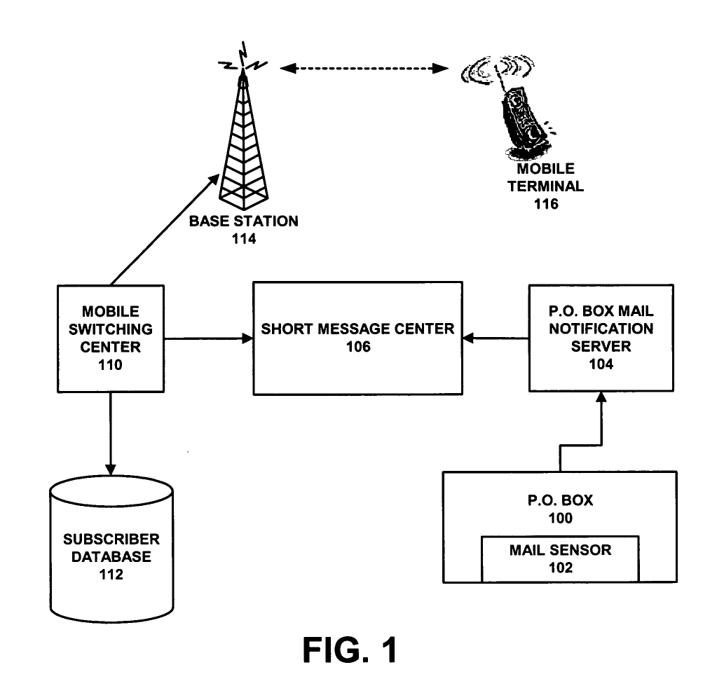

FIG. 1 depicts a mobile switching center 110 coupled to a base station 114, which communicates with a mobile terminal 116. Although the present system and method may be used with any type of network (wired and wireless, for example), the subscriber may typically be a mobile subscriber who uses a mobile terminal (also referred to as mobile phone, a cell phone, mobile handset, or car phone).

As depicted in FIG. 1, a PO Box 100 may have a mail sensor 102. The mail sensor 102 may be a weight detecting device, an optical sensor, or other device that detects when the PO Box 100 is not empty, for example when mail has been placed in the PO Box 100. When there is mail in the PO Box 100, the mail sensor 102 sends a signal to the P.O. Box Mail Notification Server 104. The P.O. Box Mail Notification Server 104 may then send a text message to the SMC 106 identifying the PO Box owner. The SMC 106 may be coupled to a mobile switching center (MSC) 110 that checks a subscriber database 112 to determine if the subscriber has subscribed to this feature.

If the subscriber has subscribed to this feature, the mobile switching center sends a message or signal to the mobile terminal 116, via the base station 114, informing the mobile terminal 116 that there is mail in the PO Box 100. Thus, the subscriber may now travel to the post office knowing that there is mail to pick up.

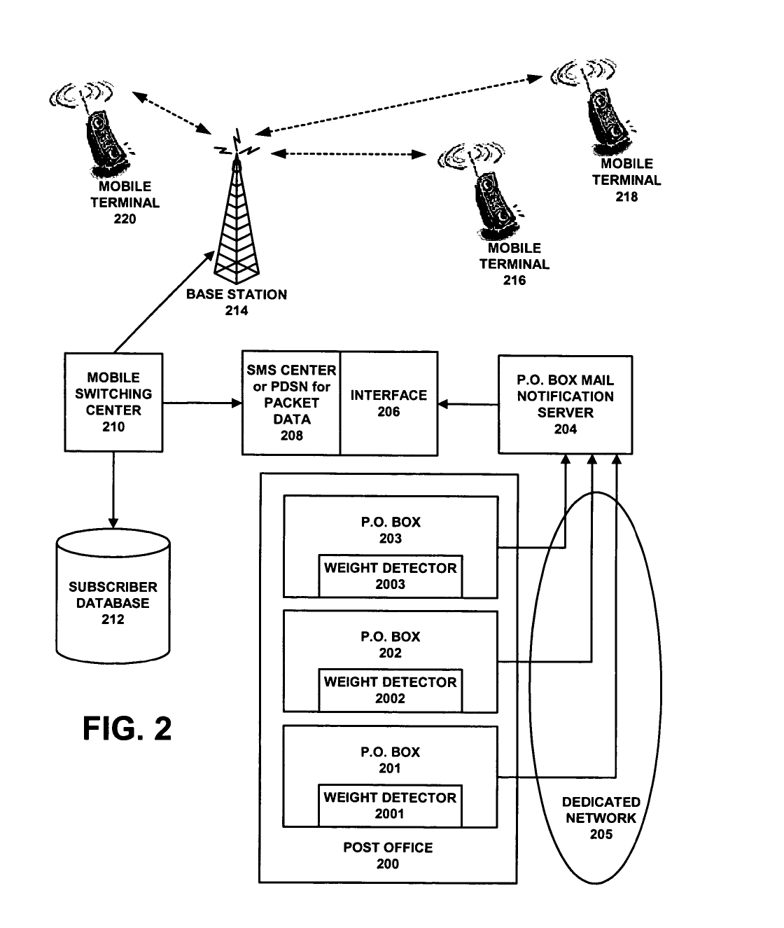

FIG. 2 illustrates a more detailed block diagram illustrative of a mobile switching center, base station, and mobile terminal for use by an embodiment of the present method and system. A post office may have a plurality of PO Boxes 201, 202, 203, each of which having a respective weight detector 2001, 2002, 2003. The weight detectors 2001, 2002, 2003 may be coupled to a “PO Box Mail Notification Server” 204 via a dedicated network 205.

When there is mail in one or more of the PO Boxes 201, 202, 203, the respective weight detector 2001, 2002, 2003 sends a signal to the P.O. Box Mail Notification Server “PO Box Mail Notification Server” 204 via a dedicated network 205. The “PO Box Mail Notification Server” 204 may then send a text message to an interface 206 of a SMC (or PDSN for packet data) 208. The SMC 208 may be coupled to a mobile switching center (MSC) 210 that checks a subscriber database 212 to determine if the subscriber has subscribed to this feature.

If the subscriber has subscribed to this feature, the mobile switching center 210 sends a message or signal to those mobile terminals of the mobile terminals 216, 218, 220, via the base station 214, which have mail to be picked up.

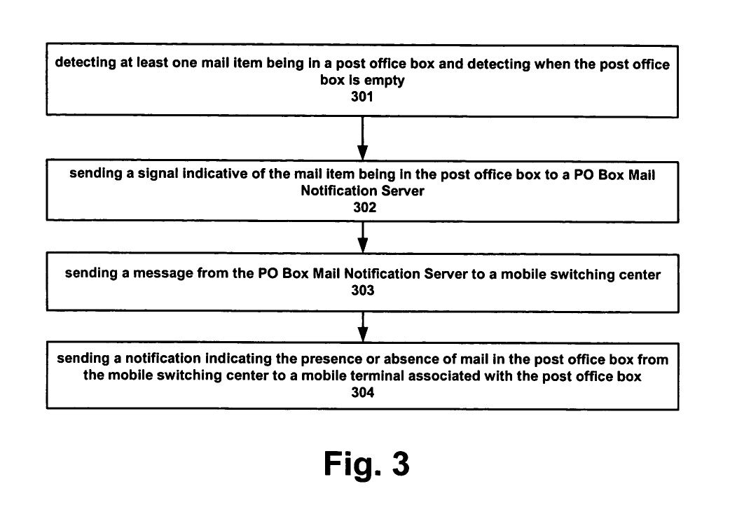

FIG. 3 is a general block diagram depicting an embodiment of the present method. In very general terms, the method has the steps of: detecting at least one mail item being in a post office box and detecting when the post office box is empty (step 301); sending a signal indicative of the mail item being in the post office box or the post office box becoming empty to a P.O. Box Mail Notification Server (step 302); sending a message from the P.O. Box Mail Notification Server to a mobile switching center (step 303); and sending a notification indicating the presence or absence of mail in the post office box from the mobile switching center to a mobile terminal associated with the post office box (step 304).

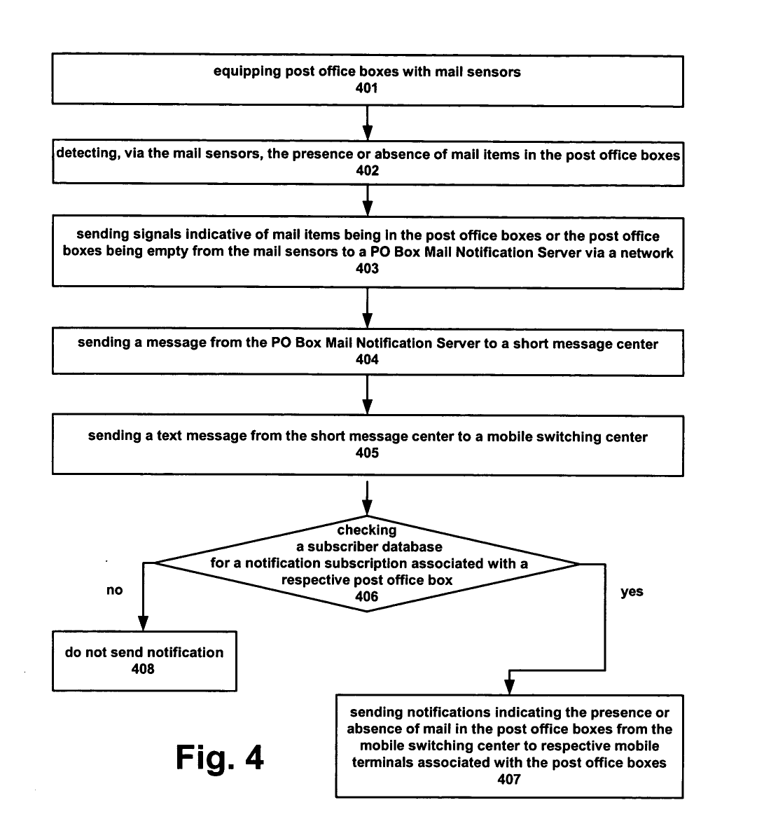

FIG. 4 is a block diagram depicting another embodiment of the present method. This embodiment of the method may have the steps of: equipping post office boxes with mail sensors (step 401); detecting, via the mail sensors, the presence or absence of mail items in the post office boxes (step 402); sending signals indicative of mail items being in the post office boxes or the post office boxes being empty from the mail sensors to a P.O. Box Mail Notification Server via a network (step 403); sending a message from the P.O. Box Mail Notification Server to a short message center (step 404); sending a text message from the short message center to a mobile switching center (step 405); checking, from the mobile switching center, a subscriber database for a notification subscription associated with a respective post office box (step 406); and, if the respective post office box is associated with a subscriber and the feature subscription is active, sending notifications indicating the presence or absence of mail in the post office boxes from the mobile switching center to respective mobile terminals associated with the post office boxes (step 407), and, if the respective post office box is not associated with a subscriber or the feature subscription is not active, not sending notifications (step 408).

The method and system of the present invention may be implemented in hardware, software, or combinations of hardware and software. In a software embodiment, portions of the present invention may be computer program products embedded in computer readable medium. Portions of the system may employ and/or comprise a set and/or series of computer instructions written in or implemented with any of a number of programming languages, as will be appreciated by those skilled in the art.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

We claim:

1. A method for notifying a post office box renter when mail is available for pickup, the method comprising the steps of:
detecting at least one mail item being in a post office box and detecting when the post office box is empty;
sending a signal indicative of the mail item being in the post office box to a P.O. Box Mail Notification Server;
sending a signal indicative of the post office box becoming empty to a P.O. Box Mail Notification Server;
sending a message from the P.O. Box Mail Notification Server to a mobile switching center; and
sending a notification indicating the presence or absence of mail in the post office box from the mobile switching center to a mobile terminal associated with the post office box.

2. The method of claim 1 wherein the method further comprises the steps of:
equipping at least one post office box with a mail sensor; and
detecting via the mail sensor a mail item in the post office box.

3. The method of claim 1 wherein the mail sensor is a weight-detecting device.

4. The method of claim 1 wherein the mail sensor is an optical device.

5. The method of claim 1 wherein the method further comprises sending the signal indicative of the mail item being in the post office box to a P.O. Box Mail Notification Server via the Internet.

6. The method of claim 1 wherein the method further comprises sending the signal indicative of the mail item being in the post office box to a P.O. Box Mail Notification Server via a dedicated network.

7. The method of claim 1 wherein the method further comprises sending a message from the P.O. Box Mail Notification Server to a short message center, and sending a text message from the short message center to the mobile switching center.

8. The method of claim 1 wherein the method further comprises checking, from the mobile switching center, a subscriber database for subscription to notification associated with the post office box.

9. The method of claim 1 wherein the method further comprises sending a notification to the mobile terminal indicative of the post office box containing mail or being empty.

10. A method for notifying a post office box renter when mail is available for pickup, the method comprising the steps of:
sending signals indicative of mail items being in post office boxes and the post office boxes being empty to a P.O. Box Mail Notification Server;
sending a message from the P.O. Box Mail Notification Server to a short message center;
sending a text message from the short message center to a mobile switching center; and
sending notifications indicating the presence of mail in the post office boxes from the mobile switching center to respective mobile terminals associated with the post office boxes.

11. The method of claim 10 wherein the method further comprises the steps of:
equipping at least one post office box with a mail sensor; and
detecting via the mail sensor a mail item in the post office box.

12. The method of claim 10 wherein the mail sensor is a weight-detecting device that detects both when mail is in the post office box and when the post office box is empty.

13. The method of claim 10 wherein the mail sensor is an optical sensor device that detects both when mail is in the post office box and when the post office box is empty.

14. The method of claim 10 wherein the method further comprises sending the signal indicative of the mail item being in the post office box to the P.O. Box Mail Notification Server via the Internet.

15. The method of claim 10 wherein the method further comprises sending the signal indicative of the mail item being in the post office box to the P.O. Box Mail Notification Server via a dedicated network.

16. The method of claim 10 wherein the method further comprises checking, from the mobile switching center, a subscriber database for subscription to notification associated with the post office box.

17. The method of claim 10 wherein the method further comprises sending a notification to the mobile terminal indicative of the post office box containing mail or being empty.

18. A system that provides network support for notifying a post office box renter when mail is available for pickup, the system comprising:
at least one post office box having a mail sensor that outputs a sensor signal indicative of at least one mail item being in the post office box;
a P.O. Box Mail Notification Server operatively coupled to the mail sensor; and
a short message center operatively coupled to the P.O. Box Mail Notification Server, the short message center outputting a text message to a mobile switching center when mail is present in the post office box;
wherein the mobile switching center sends at least one notification, which indicates the presence of mail in the post office box, to a respective mobile terminal associated with the post office box.

19. The system of claim 18 wherein the mail sensor is a weight-detecting device that detects both when mail is in the post office box and when the post office box is empty.

20. The method of claim 18 wherein the mail sensor is an optical sensor device that detects both when mail is in the post office box and when the post office box is empty.

21. The system of claim 18 wherein the signal indicative of the mail item being in the post office box is sent to the P.O. Box Mail Notification Server via the Internet.

22. The system of claim 18 wherein the signal indicative of the mail item being in the post office box is sent to the P.O. Box Mail Notification Server via a dedicated network.

23. The system of claim 18 wherein the system further comprises checking, from, a subscriber database that is checked by the mobile switching center for a subscription associated with the post office box for notification of the mail item being in the post office box.
